(19) United States
(12) Patent Application Publication
(10) Pub. No.: US 2007/0149255 A1
(43) Pub. Date: Jun. 28, 2007

(54) System for backing up information of a handheld electronic device and method thereof

(75) Inventor: Hai-Ping Luo, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/528,464

(22) Filed: Sep. 28, 2006

(30) Foreign Application Priority Data
Dec. 27, 2005 (TW) 094146624

(51) Int. Cl. H04B 1/38; H04M 1/00

(52) U.S. Cl. 455/573

(57) ABSTRACT

In a system for backing up information of a handheld electronic device and method thereof, a handheld electronic device includes a charging circuit for receiving a current, a battery for supplying electric power, a transmission interface for transmitting a signal, a first memory for storing user information and a software program, and a charger including a second memory, such that when the handheld electronic device is charged, the handheld electronic device transmits a copy of the user information stored in the first memory into the second memory of the charger through the transmission interface by executing the software program.

### FIELD OF THE INVENTION

The present invention relates to a system and a method for backing up information, and more particularly to a system for backing up information of a handheld electronic device and method thereof.

### BACKGROUND OF THE INVENTION

In recent years, network and communication are blooming and thus various network and communication equipments are developed continuously and used extensively in our life and working environment. Such development trend not only expedites the speed and efficiency for circulating information, but also brings tremendous convenience to our life and work.

As the electronic industry advances, various different handheld electronic products such as mobile phones (or handsets) come with a light, thin, short and compact design, and their price become lower and lower. Further, these handheld electronic products also include additional functions, and thus mobile phones are no longer a simple mobile phone anymore, but they include many other functions as well.

However, the original design of the mobile phone is intended for allowing users to communication with others anytime. Due to the bandwidth of the current global system of mobile communication (GSM) and analog advanced mobile phone system (AMPS) cannot bear the transmission of huge data, and thus they can transmit sound and a small amount of graphics only. As the era of integrating communications with computers has arrived, the present mobile phones not only provide the main communication function, but also integrate wireless transmission and notepad functions, and thus a smart phone integrating a mobile phone with a personal digital assistance (PDA) was developed. In addition to serving as a mobile communication tool for voice communications, smart phones also have a personal information management function as well as the functions of logging on the Internet to send or receive E-mails, play games, read news, and download information. With a modem or an Intranet link and a comfortable touch and screen display, such mobile phone becomes a powerful third-generation (3G) or 3.5G mobile phone.

At present, these mobile phones have become one of the most popular electronic products and also the most popular personal communication device having a large memory storage for storing a great deal of user information, and a telephone directory in the mobile phones is important information to users. Many users have the experience of missing or damaging a mobile phone, and once the current mobile phone is lost, the information stored in a telephone directory of these mobile phones will be lost, too, and thus usually bringing serious damages to users.

In general, the mobile phone and its charger will not be missing or damaged at the same time, and thus the present invention makes use of such situation and adopts a charger to backup the telephone directory information stored in the mobile phone while the mobile phone is being charged. Therefore, the telephone directory information can be kept concurrently in the mobile phone and the charger.

Referring to FIG. 1 (prior art) for the schematic view of a charging structure of a mobile phone according to a prior art, the prior art comprises a mobile phone 10, a charger 11 and a battery 12. The mobile phone 10 includes a charging circuit (charge IC) 101, a transmission interface (baseband) 102, a memory 103 and a low drop-out linear regulator (LDO) 104, wherein the charging circuit 101 is used for absorbing a current; the transmission interface 102 is used for transmitting digital signals without requiring complicated and frequent switches and it generally needs one channel to be maintained at a standby mode only; the memory 103 is used for storing a system program and user information; the low drop-out linear regulator 104 is used for reducing excessive voltage from the input voltage to generate a modulated output voltage; the charger 11 is used for outputting a voltage; and the battery 12 is used for supplying electric power.

After the charger 11 outputs a 5V voltage to the charging circuit 101, the charging circuit 101 will absorb current from the charger 11 to the battery 12 for charging the battery, such that if the mobile phone 10 uses the battery 12 for charging, the battery 12 will output a voltage to the low drop-out linear regulator 104 and the voltage passes from the low drop-out linear regulator 104 to supply electric power to each module (including the transmission interface 102 and the memory 103) in the mobile phone 10. If the mobile phone 10 uses the charging circuit 101 for supplying electric power, the charging circuit 101 will output a voltage to supply electric power to each module (including the transmission interface 102 and the memory 103) in the mobile phone 10.

The telephone directory information of the mobile phone 10 is generally stored in a memory 103 such as a flash memory and/or a subscriber identity module (SIM) card of the mobile phone 10. If the mobile phone 10 as shown in FIG. 1 is missing or damaged, then the telephone directory information cannot be recovered, and thus bringing tremendous loss or trouble to users.

### SUMMARY OF THE INVENTION

Therefore, it is a primary objective of the present invention to provide a system for backing up information and method thereof for effectively overcoming emergency situations of a handheld electronic device (such as losing or damaging the handheld electronic device), so that the information stored in the handheld electronic device can be backed up into a charger to prevent damages or troubles to the handheld electronic device users.

To achieve the foregoing objective, the technical measure taken by the invention includes a handheld electronic device comprising a charging circuit, a battery, a transmission interface and a memory, wherein the charging circuit is used for absorbing current, and the battery is used for supplying electric power, and the transmission interface is used for transmitting digital signals and maintained at a standby mode all the time, and the memory is used for storing user information (such as telephone directory information) and a software program. The charger includes another memory, such that when the handheld electronic device uses the charger for charging, the handheld electronic device executes the software program to back up the information in the memory to another memory of the charger through the transmission interface, so as to achieve the objective of backing up the information of the handheld electronic device.

### BRIEF DESCRIPTION OF THE DRAWINGS

FIG. 1 is a schematic view of a charge structure of a mobile phone according to a prior art;

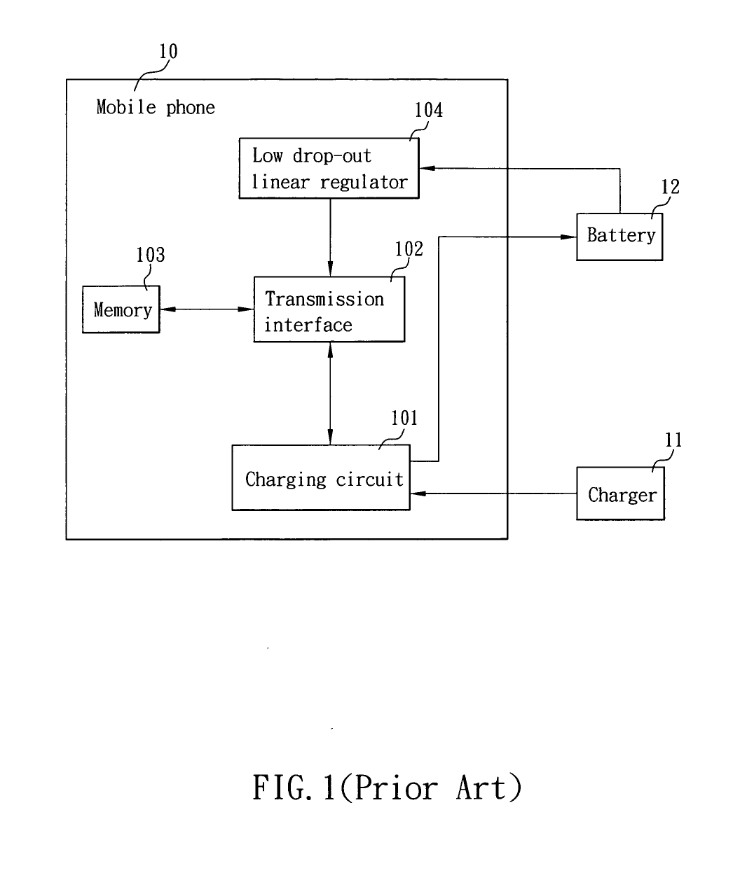

FIG. 2 is a schematic view of a structure of the present invention;

FIG. 3 is a flow chart of the present invention; and

FIG. 4 is another flow chart of the present invention.

### DETAILED DESCRIPTION OF THE PREFERRED EMBODIMENTS

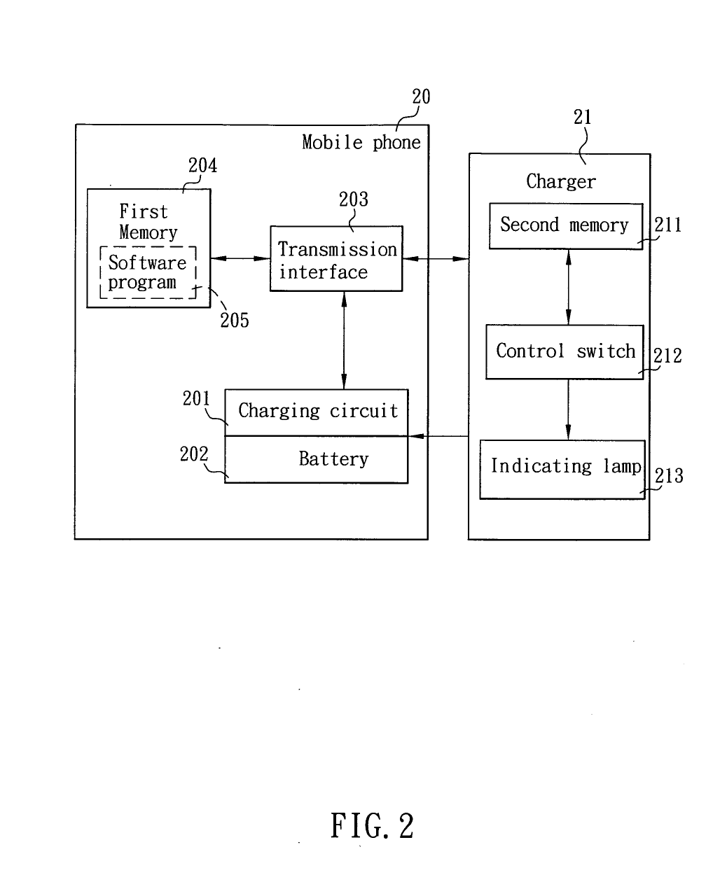

Referring to FIG. 2 for the schematic view of a structure of a system for backing up information of a handheld electronic device according to a preferred embodiment of the present invention, the system comprises a handheld electronic device (which is a mobile phone 20 in this embodiment) and a charger (or an adapter) 21. The mobile phone 20 includes a charging circuit (charge IC) 201, a battery 202, a transmission interface (baseband) 203 and a first memory 204, wherein the charging circuit 201 and the battery 202 are used for supplying electric power to handheld electronic device; the transmission interface 203 is used for transmitting a signal from the first memory; and the first memory 204 is used for storing user information and a software program 205.

Further, user information (such as telephone book information) of the mobile phone 20 is generally stored in the first memory (such as a flash memory and a subscriber identity module (SIM) card) of the mobile phone 20.

With the foregoing basic architecture, the technical measure of the present invention can be implemented. In FIG. 2, the first memory 204 of the mobile phone 20 contains a software program 205, and the charger 21 which includes a second memory 211, such that the handheld electronic device transmits a copy of the user information (such as the telephone book information) stored in the first memory 204 into the second memory 211 through the transmission interface 203 by the execution of the software program 205, when the charger charges the handheld electronic device by charging the battery 202. Thus, the user information stored in the charger 21 and the user information stored in the mobile phone 20 are maintained the same consistently. With the design of adding the second memory 211 in the charger 21 according to the present invention, the objective of backing up the user information in the mobile phone 20 can be achieved.

In a preferred embodiment of the present invention, the second memory 211 preferably comes with a least possible number of data lines to reduce the number of cables for the charger 21. Since the user information data stored in the mobile phone 20 is not large, therefore if there is no particular requirement for the data transmission rate, the memory 211 adopting a general serial access memory can satisfy the requirements.

In another preferred embodiment of the present invention, the charger 21 further includes a control switch 212 and an indicating lamp 213. The control switch 212 is used for controlling whether to back up the information (such as the telephone directory information) stored in the first memory 204 into the second memory 211 (In other words, if the control switch 212 is on and the mobile phone is charged, automatically backing up the information stored in the first memory 204 to the second memory 211) or recover the information from the second memory 211 and transmit into the first memory 204 in the mobile phone 20 (In other words, if the control switch 212 is off and the mobile phone is charged, allowing users to determine whether to recover the information from the second memory 211). If a user decides to recover the information from the second memory 211, the software program 205 retrieves the information from the second memory 211 and transmits the information to the first memory 204 in the mobile phone 20, and thus the information stored in the second memory 211 of the charger is used for recovering the information stored in the mobile phone 20. Further, the charger 21 will drive the indicating lamp 213 to indicate the completion of a data transmission, after the information stored in the first memory 204 has been sent to the second memory 211 of the charger 21.

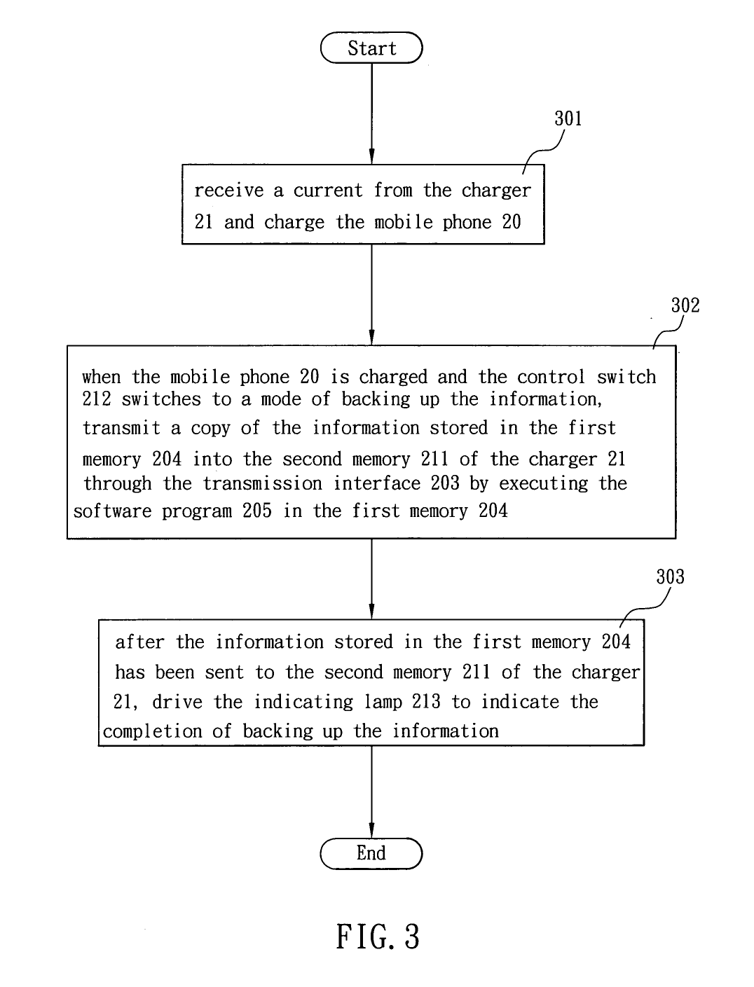

In another preferred embodiment of the present invention, a method of backing up information in a handheld electronic device in accordance with the invention comprises the following steps. When backing up the information stored in the first memory 204 to the second memory 211, the following procedure as shown in FIG. 3 will take place.

In Step 301, the charging circuit 201 of the mobile phone 20 receives a current from the charger 21 and charges the mobile phone 20.

In Step 302, when the mobile phone 20 is charged and the control switch 212 switches to a mode of backing up the information, a copy of the information stored in the first memory 204 is transmitted into the second memory 211 of the charger through the transmission interface 203 by executing the software program 205 in the first memory 204.

In Step 303, after the information stored in the first memory 204 has been sent to the second memory 211 of the charger 21, the charger 21 will drive the indicating lamp 213 to indicate the completion of backing up the information, and then end the process for that particular time.

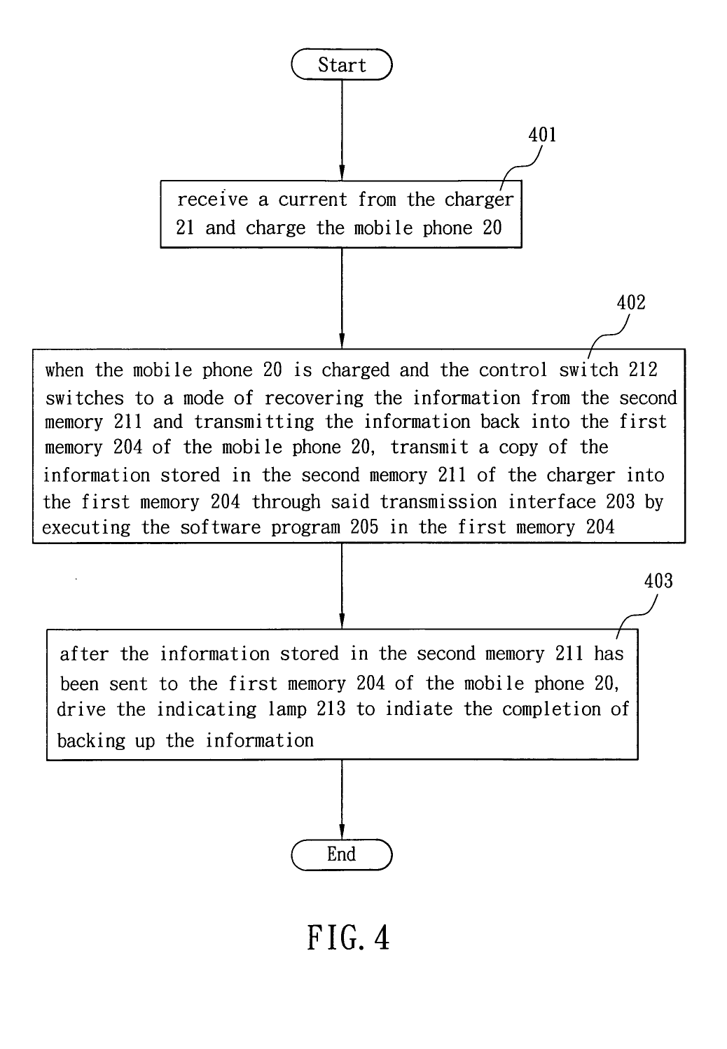

If the mobile phone 20 uses the charger 21 for charging, and the control switch 212 switches to a mode of recovering the information from the second memory 211 and transmitting to the information back into the first memory 204 of the mobile phone 20, the following procedure as shown in FIG. 4 will take place.

In Step 401, the charging circuit 201 of the mobile phone 20 receives a current from the charger 21 and charges the mobile phone 20.

In Step 402, when the mobile phone 20 is charged and the control switch 212 switches to a mode of recovering the information from the second memory 211 and transmitting the information back into the first memory 204 of the mobile phone 20, a copy of the information stored in the second memory 211 of the charger is transmitted into the first memory 204 through said transmission interface 203 by executing the software program 205 in the first memory 204.

In Step 403, after the information stored in the second memory 211 has been sent to the first memory 204 of the mobile phone 20, the charger 21 will drive the indicating lamp 213 to indicate the completion of backing up the information and then end the process for that particular time.

What is claimed is:

1. A system for backing up information in a handheld electronic device, comprising:
a handheld electronic device, comprising:
a charging circuit and a battery for supplying electric power to the handheld electronic device;
a first memory for storing a user information and a software program; and
a charger comprising a second memory,
wherein when the charger charges said handheld electronic device by charging the battery, by executing of the software program said handheld electronic device transmits a copy of the user information stored in said first memory into said second memory of said charger through a transmission interface.

2. The system of claim 1, wherein said charger comprises a control switch for controlling whether to back up the information stored in said first memory into said second memory.

3. The system of claim 2, wherein said control switch is used for controlling whether to recover the information from the second memory and transmit into said first memory in said handheld electronic device.

4. The system of claim 1, wherein said charger comprises an indicating lamp for indicating the progress of backing up the information.

5. The system of claim 4, wherein said indicating lamp is used for indicating a completion of backing up the information stored in said first memory into said second memory.

6. The system of claim 1, wherein said second memory is a serial access memory.

7. The system of claim 1, wherein said second memory preferably comprises a least possible number of data lines.

8. The system of claim 1, wherein the information is a user's personal information.

9. The system of claim 8, wherein said information is telephone book information.

10. The system of claim 1, wherein said handheld electronic device is a handheld communication device.

11. The system of claim 10, wherein said handheld electronic device is a mobile phone.

12. A method for backing up information in a handheld electronic device into a charger, wherein said handheld electronic device comprises a charging circuit, a transmission interface and a first memory containing information, said charger comprises a second memory, and the method comprises the steps of:
the charging circuit receiving a current from said charger and charging said handheld electronic device; and
by executing a software program stored in said first memory, transmitting a copy of said information stored in said first memory into said second memory of said charger through said transmission interface.

13. The method of claim 12, wherein said charger further comprises a control switch for controlling whether to back up said information stored in said first memory into said second memory.

14. The method of claim 13, wherein said control switch is used for controlling whether to recover said information from said second memory and transmit into said first memory of said handheld electronic device.

15. The method of claim 12, wherein said charger further comprises an indicating lamp for indicating the progress of backing up said information.

16. The method of claim 15, wherein said indicating lamp indicates a completion of backing up said information stored in said first memory into said second memory.

17. The method of claim 12, wherein said information is telephone book information.

18. The method of claim 12, wherein said handheld electronic device is a mobile phone.

19. The method of claim 14, wherein after said control switch switches to a mode of recovering said information from said second memory and transmitting said information back into said first memory of said handheld electronic device, the method further comprises the steps of:
the charging circuit receiving a current from said charger and charging said handheld electronic device; and
by executing the software program in said first memory, transmitting the copy of said information stored in said second memory into said first memory through said transmission interface.
